(19) United States
(12) Patent Application Publication
(10) Pub. No.: US 2016/0159637 A1
(43) Pub. Date: Jun. 9, 2016

(54) SADDLE TREE FOR A RIDING SADDLE

(71) Applicant: IVKO INDUSTRIEPRODUKT VETRIEBSKONTAKT GMBH, Baar (DE)

(72) Inventor: Jutta KAHLBETZER, Baar (DE)

(21) Appl. No.: 14/905,365

(22) PCT Filed: Jul. 16, 2013
(86) PCT No.: PCT/EP2013/065023

§ 371 Date: Jan. 15, 2016

(51) Int. Cl. B68C 1/02

(52) U.S. Cl. CPC B68C 1/025

(57) ABSTRACT

A saddle tree is provided for a riding saddle, in which the saddle tree has a single- or multi-component frame structure (10) having at least one wooden frame element (11). A reinforcing structure (12) at least partially surrounds the wooden frame element. The reinforcing structure includes fibers (14) embedded in a binder matrix (13).

### CROSS-REFERENCE TO RELATED APPLICATIONS

This application is a Section 371 of International Application No. PCT/EP2013/065023, filed Jul. 16, 2013, which was published in the German language on Jan. 22, 2015, under International Publication No. WO 2015/007311 A1 and the disclosure of which is incorporated herein by reference.

### FIELD OF THE INVENTION

The invention relates to a saddle tree for a riding saddle having a single-component or multi-component frame structure comprising at least one wooden frame element, and also to a method for producing such a saddle tree for a riding saddle.

### BACKGROUND OF THE INVENTION

According to the prior art, only rather massive saddle trees made of wood could be built to dimension, because wood requires certain minimum thicknesses. Saddles that require a thin saddle tree structure, as for example jumping saddles, are typically made of plastic, metal, or carbon.

Small batches or individual productions could then be manufactured only at extremely high costs, because each manufacturing run requires a custom mold for creating the plastic, metal, or carbon tree, in order to ensure, for example, an accurately fitting shape for the respective horse type.

### BRIEF SUMMARY OF THE INVENTION

The object of the invention is to provide a saddle tree that can also be manufactured in small batches or to individual dimensions, especially also with thin saddle tree constructions.

This object is achieved in terms of a device having a saddle tree of the type described at the outset having at least one wooden frame element as well as a reinforcing structure surrounding the wooden frame element at least in some sections, wherein the reinforcing structure comprises fibers embedded in a binder matrix. The object is further achieved in terms of a method for producing such a saddle tree, the method comprising the steps of lining the wooden frame element with fibers and binding the fibers in a binder matrix. Advantageous embodiments are specified in the description below and in the dependent claims.

A core idea of the invention is based on a single-component or multiple-component frame structure being used in a known way with at least one wooden frame element, but this wooden frame element is reinforced correspondingly by a fiber-binder matrix, so that thin structures can also be realized.

With this design according to the invention, it is also possible to create very thin saddle tree structures from wood, so that, for example, jumping saddles can be manufactured with a saddle tree made of wood. It will be understood that adaptations to individual dimensions are possible with relatively low expense, because there are no costs for molds. In this respect, the design according to the invention completely eliminates the costs for molds and leads to a big improvement in terms of technology, weight, and appearance and also allows the mass production of saddles. On one hand, production using CNC technology is made possible and, on the other hand, the fiber-binder matrix ensures very high stability.

According to the invention, a saddle tree for a riding saddle is proposed in this respect having a single-component or multiple-component frame structure, wherein the single-component or multiple-component frame structure comprises at least one wooden frame element and a reinforcing structure surrounding the wooden frame element at least in some sections, wherein the reinforcing structure comprises fibers embedded in a binder matrix.

The method according to the invention for producing a saddle tree for a riding saddle, wherein the saddle tree has a single-component or multiple-component frame structure, comprising at least one wooden frame element and a reinforcing structure surrounding the wooden frame element at least in some sections, here comprises the following steps:
Lining the wooden frame with fibers and
Binding the fibers in a binder matrix.

In one preferred embodiment of the saddle tree according to the invention, the fibers are inorganic or organic fibers, in particular carbon fibers, or they contain at least inorganic and/or organic fibers, in particular carbon fibers. Especially using carbon fibers has produced good results. Carbon fibers can also be produced relatively inexpensively and allow good processing.

The fibers can be introduced individually or as a woven fabric or scrim fabric or multi-axial scrim fabric or knitted fabric or mesh or matting or non-woven fabric.

For improving the adhesion of the fibers to the wooden structure and/or for improving the connection between the wooden frame element and the reinforcing structure, a bonding or adhesive layer can be deposited on the wooden frame, wherein the fibers are fixed on this bonding or adhesive layer during the creation of a saddle tree according to the invention. Here, the fibers can then be provided with a binder, in order to form a continuous reinforcing structure that binds the fibers. The binder can be a synthetic resin, for example an epoxy resin, an unsaturated polyester resin, a vinyl ester resin, a phenol formaldehyde resin, a diallyl phthalate resin (DAP), a methacrylate resin (MMA), a polyurethane (PUR), or an amino resin, such as melamine resin or urea resin.

The fibers can be non-directed or arranged and fixed with a predetermined preferred direction on the wooden frame element. By a directional placement, a modulus of elasticity in each desired direction can be set within a certain range, so that a total elasticity of the saddle can be influenced in the desired way.

Furthermore, a riding saddle is also proposed that comprises a saddle tree according to the invention, wherein the saddle tree is coated completely or partially with a saddle coating, in particular made of leather. In this respect, it is also possible in one alternative that for a riding saddle placed on a horse at a later time, parts of the saddle tree remain visible or are completely covered by the saddle coating. The first alternative produces a certain amount of weight savings. In addition, for aesthetic reasons it can also be desirable to allow parts of the saddle tree to extend out from under the saddle coating, so that these parts remain visible.

With respect to the already described method, it can be advantageous, for simplifying the lining of the wooden frame element with fibers and/or for improving the bonding of the reinforcing structure to the wooden frame element, to deposit a bonding or adhesive layer before the wooden frame element is lined with fibers, where these fibers are fixed to this layer.

The binder matrix can be deposited in a preferred construction by brushing, spraying, dipping, rolling, or coating by a doctor knife.

The fibers can be oriented randomly, as already mentioned, or deposited with a certain desired orientation.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a perspective view of a saddle tree according to an embodiment of the invention.

FIG. 2 is an enlarged detail view of the region 2 of FIG. 1, showing a schematic view of the reinforcing structure according to the embodiment of FIG. 1.

FIG. 3 is a section view along line through the wooden frame as part of the saddle tree of FIG. 1 and provided with a reinforcing structure according to an embodiment of the invention.

FIG. 3A is an enlarged detail view of the region A of FIG. 3, showing schematically the fiber-resin matrix of the reinforcing structure according to an embodiment of the invention.

### DETAILED DESCRIPTION OF THE INVENTION

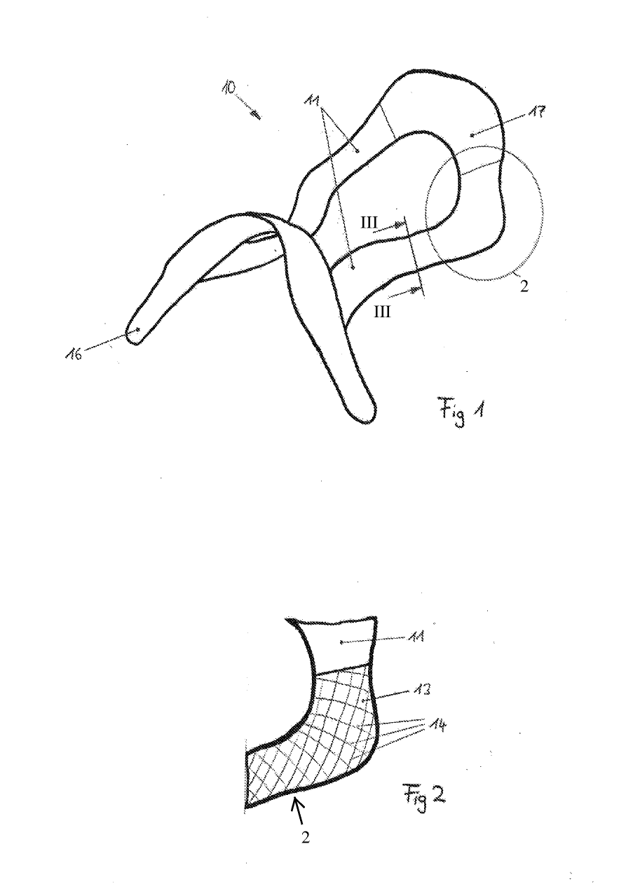

In FIGS. 1 and 2, a saddle tree is shown as an example, wherein completely different frame structures 10 are also conceivable and known for saddle trees. In the present case, two longitudinally curving wooden frame elements 11 are provided, which are connected to each other at a rear end by a rear connection structure 16 and at a front end by a front connection structure 17. The rear connection structure 16 and front connection structure 17 do not absolutely even have to be made of wood, but can instead be formed from other suitable materials, for example plastic, or optionally even other composite materials.

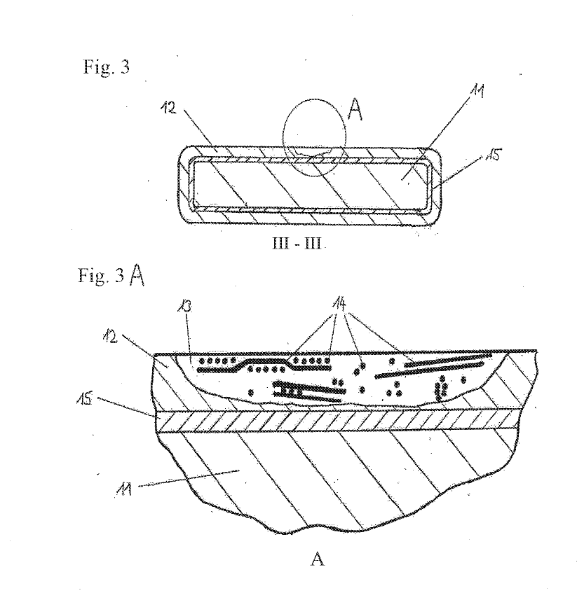

The two wooden frame elements 11 are surrounded according to FIGS. 3 and 3A with a reinforcing structure 12 according to the invention. The reinforcing structure 12 according to the invention is here produced as follows:

On the wooden frame element 11, a bonding or adhesive layer 15 is deposited on which the fibers 14 are placed individually or as a scrim fabric or woven fabric. Then, the fibers 14 are embedded in a binder matrix 13 by the deposition of a binder, which is, for example, brushed on.

In a first alternative variant of the invention, the wooden frame element or elements 11 are already surrounded with the reinforcing structure 12 according to the invention before they are combined for forming the frame structure 10 of the saddle tree. Alternatively, it is possible to first combine the wooden frame element or elements together into the frame structure 10 of the saddle tree and only then to surround it with the connection structure 12. For saddle trees formed from a single-component wooden frame element, the step of assembling into the frame structure 10 is naturally omitted.

With the invention, visually appealing saddle trees can be individually adapted or even created in small batch sizes for special requirements.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the invention as defined by the appended claims.

1.-12. (canceled)

13. A saddle tree for a riding saddle, the saddle having a single-component or multiple-component frame structure comprising at least one wooden frame element and a reinforcing structure at least partially surrounding the wooden frame element, wherein the reinforcing structure comprises fibers embedded in a binder matrix.

14. The saddle tree according to claim 13, wherein the fibers comprise at least partially inorganic and/or organic fibers.

15. The saddle tree according to claim 14, wherein the fibers comprise at least partially carbon fibers.

16. The saddle tree according to claim 13, wherein the fibers are deposited individually or as a woven fabric or knitted fabric.

17. The saddle tree according to claim 13, wherein the reinforcing structure comprises a bonding or adhesive layer facing the wooden frame element of the saddle tree, wherein the fibers are fixed by the bonding or adhesive layer in a production process of the saddle tree.

18. The saddle tree according to claim 17, wherein, for forming the reinforcing structure, the fibers fixed by the bonding or adhesive layer are then provided with a binder for forming the binder matrix, in order to form a uniform reinforcing structure binding the fibers.

19. The saddle tree according to claim 13, wherein the binder comprises a synthetic resin.

20. The saddle tree according to claim 19, wherein the synthetic resin is selected from an epoxy resin, an unsaturated polyester resin, a vinyl ester resin, a phenol formaldehyde resin, a diallyl phthalate resin (DAP), a methacrylate resin (MMA), a polyurethane (PUR), and an amino resin.

21. The saddle tree according to claim 20, wherein the amino resin is selected from a melamine resin and a urea resin.

22. The saddle tree according to claim 16, wherein the fibers are arranged or fixed in a non-directed way or with a certain preferred direction on the wooden frame element.

23. A riding saddle comprising a saddle tree according to claim 18, wherein the saddle tree is at least partially coated with a saddle coating.

24. The riding saddle according to claim 23, wherein the saddle coating is made of leather.

25. A method for producing a saddle tree for a riding saddle, wherein the saddle tree has a single-component or multiple-component frame structure comprising at least one wooden frame element and a reinforcing structure at least partially surrounding the wooden frame element, the method comprising steps of:
lining the wooden frame element with fibers, and
binding the fibers in a binder matrix.

26. The method according to claim 25, further comprising a step of depositing a bonding or adhesive layer to the wooden frame element before the lining step, and fixing the fibers to the bonding or adhesive layer.

27. The method according to claim 25, wherein the binder matrix is deposited by a method selected from brushing, spraying, dipping, rolling, and coating by a doctor knife.

28. The method according to claims 25, wherein the fibers are oriented randomly or are deposited with a certain desired orientation.
